(19) United States
(12) Patent Application Publication
(10) Pub. No.: US 2025/0043371 A1
(43) Pub. Date: Feb. 6, 2025

(54) COMPOSITE ADDITIVE FOR FORMING INCLUSIONS WITH CORE-SHELL STRUCTURE, PREPARATION METHOD AND SMELTING METHOD

(71) Applicants: WUHAN UNIVERSITY OF SCIENCE AND TECHNOLOGY, Wuhan (CN); WUKE XINCAI (WUHAN) TECHNOLOGY CO., LTD, Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(72) Inventors: Kaiming WU, Wuhan (CN); Shaoguan XIANG, Wuhan (CN)

(73) Assignees: WUHAN UNIVERSITY OF SCIENCE AND TECHNOLOGY, Wuhan (CN); WUKE XINCAI (WUHAN) TECHNOLOGY CO., LTD., Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(21) Appl. No.: 18/436,044

(22) Filed: Feb. 8, 2024

(30) Foreign Application Priority Data
Aug. 3, 2023 (CN) 2023109719955

(51) Int. Cl. C21C 7/00; C21C 7/06; C22C 33/04; C22C 38/00; C22C 38/14

(52) U.S. Cl. CPC C21C 7/0006; C21C 7/06; C22C 33/04; C22C 38/002; C22C 38/005; C22C 38/14

(57) ABSTRACT

A composite additive for forming inclusions with a core-shell structure, a preparation method and a smelting method are provided. The composite additive includes the following chemical components by mass percentage: Fe: 41-59%, Zr: 5-11%, Ti: 14-26%, Mg: 11-19%, and RE: 4-10%, in which the mass percentage content of Zr element, Ti element, Mg element and RE element satisfies a formula: (Ti+Mg+RE)/Zr=4-8. The composite additive for forming inclusions with a core-shell structure has the characteristics of fineness, spheroidization and obvious dispersion effect. This type of inclusions has a bulk modulus similar to that of the iron matrix, which can significantly improve the plasticity, toughness, fatigue resistance, local corrosion resistance, welding performance, cold bending performance, etc. of steel materials, suitable for steel types with strict requirements on the shape of inclusions, such as marine steel, pipeline steel, container steel, cold heading steel, tool and die steel, etc.

### CROSS REFERENCE TO THE RELATED APPLICATIONS

This application is based upon and claims priority to Chinese Patent Application No. 202310971995.5, filed on Aug. 3, 2023, the entire contents of which are incorporated herein by reference.

### TECHNICAL FIELD

The present invention relates to the technical field of smelting, in particular to a composite additive for forming inclusions with a core-shell structure, a preparation method and a smelting method.

### BACKGROUND

Iron and steel materials are the foundation of manufacturing industry, the most important structural material used by human society, and play a pivotal role in economic and social development. Steel purification technology is the basis for producing high-performance, high-quality products. Since the 1980s, the cleanliness of steel has been continuously improved. However, there are still situations where the service performances of these materials such as fatigue resistance and local corrosion resistance cannot meet the requirements of economic and social development during use. The main reason is the lack of in-depth understanding of the formation process, microscopic mechanism and control methods of inclusions in steel. Inclusions in steel (mainly oxide inclusions) seriously affect the quality of steel. The existence of inclusions in the steel destroys the continuity of the metal and reduces the mechanical properties, physical properties, chemical properties and process properties of the steel. Inclusions in steel mainly exist in the form of non-metallic compounds, such as oxides, sulfides, nitrides, etc., which cause uneven structure of steel and affect the physical, mechanical, and chemical properties of steel. The inclusions in the steel reduce the plasticity, toughness and fatigue life of the steel, deteriorate the processing performance of the steel, and have a direct impact on the surface finish, welding performance and local corrosion resistance of the steel. For example, inclusions in steel can cause surface defects in thin steel sheets for automobiles and electrical products, cracks in thin steel sheets for DI tanks, hydrogen-induced cracks in pipeline steel, wire breakage during tire meridian processing, and deterioration of fatigue performance in bearing steel. Meanwhile, non-metallic inclusions in steel also have adverse effects on the tear resistance, low temperature impact toughness, and seawater corrosion resistance of the steel plate.

The smelting, casting, solidification and crystallization of steel involve complicated physical and chemical processes. Endogenous inclusions are various compounds produced by complicated chemical reactions during the liquid and solidification process of steel. When the molten steel solidifies, they have no time to float up and become embedded in the steel. Or, they are non-metallic substances dissolved in the steel at high temperature. When the temperature of the molten steel decreases, the solubility of these non-metallic substances in the steel decreases and thus they are precipitated from the steel, and exist in the steel in the form of inclusions.

Among them, oxide inclusions in steel are the main type of inclusions. Al₂O₃, MgO, CaO and other oxides, complex oxides such as calcium aluminate, magnesium aluminate, aluminum-magnesium spinel, etc. are the main forms of oxides in steel. Such inclusions are easy to deposit inside the submerged nozzle to cause nozzle blockage, and also cause surface defects of steel products, reducing the surface finish of steel. Al₂O₃ is the most common type of oxide inclusions that have the greatest impact on the quality of steel. It belongs to brittle non-deformable inclusions, and is quite different from the thermal deformation ability of the matrix. Brittle inclusions such as bulk Al₂O₃, under the stress from hot working, are deformed and broken into inclusions with sharp water chestnuts, and distributed in the matrix in chains. These hard irregular Al₂O₃ inclusions can scratch the matrix, and generate a stress concentration field around the inclusions until they form voids or cracks at the interface. For example, in medium and high carbon steels, especially in bearing steels and heavy rail steels, Al₂O₃ inclusions will become fatigue sources under the action of cyclic stress, and eventually cause “piece dropping”, i.e., large pieces of metal falling off, due to the expansion of fatigue cracks, and thus result in steel breakage.

For general structural steels, the sulfides in the steel have little effect on the strength of the steel at room temperature, but their content and shape have a great influence on the toughness of the steel (such as the reduction of area and impact toughness, etc.), especially the low temperature toughness. For most steel grades, increased sulfur content reduces the properties of the steel. At the hot working temperature, MnS inclusions are easily extended into strips, resulting in anisotropy of steel toughness. The composition of sulfide inclusions also has a significant impact on product performance. Manganese sulfide inclusions are easily deformed during rolling, while calcium sulfide is relatively hard and actually does not deform during rolling. Sulfides have the potential for hydrogen-induced cracking. Because hydrogen is easily trapped by elongated MnS inclusions, it reduces the resistance to hydrogen-induced cracking. The weldability, machinability, and mechanical properties of steel are also affected by the type and quantity of sulfide inclusions in steel. The sulfide present in steel in the form of web will cause hot embrittlement of steel.

The influence of inclusions in steel on properties involves many factors. The amount, particle size, shape and distribution of inclusions in steel, the bonding force between inclusions and steel matrix, the plasticity and elastic coefficient of inclusions, thermal expansion coefficient, hardness and many other factors will affect the properties of steel. If technical measures are taken to effectively control inclusions in steel, not only can their harmful effects be eliminated, but also their beneficial effects can be brought into play. Large and concentrated inclusions are very harmful to the performance of steel, while inclusions with dispersed and fine particles can not only eliminate their harm, but sometimes improve the performance of steel. For example, the use of fine and dispersed oxides with excellent high temperature stability in steel can improve the welding performance of steel, especially the welding performance under the condition of resistance to large heat input.

In the general smelting process, metals such as ferromanganese, ferrosilicon and aluminum are mostly used as deoxidizers. The oxides formed by deoxidizer bonded with oxygen cannot float up to the steel slag to remove them, that is, they become non-metallic inclusions in the steel. Nitrogen is usually also a harmful element in steel, and its solubility in steel is extremely small. At the same time, nitrogen has a strong affinity with elements such as titanium, vanadium, and niobium. In addition, molten steel can absorb a large amount of nitrogen from the atmosphere, so nitride inclusions are easy to appear in steel.

The existing Al deoxidation process, that is, the deoxidation by Al blocks, Al grains, Al wires, and Fe—Al alloys is a conventional deoxidation technology. The deoxidation product Al₂O₃ is the most common type of oxide inclusions that have the greatest impact on steel quality. It belongs to brittle non-deformable inclusions, and is quite different from the thermal deformation ability of the matrix. Brittle inclusions such as bulk Al₂O₃, under the stress from hot working, are deformed and broken into inclusions with sharp water chestnuts, and distributed in the matrix in chains. These hard and irregular Al₂O₃ inclusions can scratch the matrix and generate a stress concentration field around the inclusions until voids or cracks are formed at the interface.

The existing Ca treatment is the most widely used smelting technology to improve the morphology of inclusions in contemporary metallurgy. Ca is a very good purifying agent for molten steel. It can not only deoxidize deeply, but also desulfurize deeply. After the molten steel is deoxidized, when [O] is already very low, the direct deoxidation reaction of Ca becomes a secondary process. In this case, it mainly reacts with Al₂O; in steel to form calcium aluminate. In this way, not only the deoxidation problem is solved, but also the Al₂O₃ inclusions in the steel are reduced, but some calcium aluminate inclusions that have not been removed by floating still remain in the steel. For steel materials with special performance requirements such as local corrosion resistance, fatigue resistance, and cold resistance performance, the problem cannot be fundamentally addressed.

One way to control non-metallic inclusions in steel is to reduce the generation of inclusions during the smelting and casting process and the pollution of foreign inclusions to molten steel, and the second one is to try to eliminate the inclusions that already exist in molten steel or reduce the damage of inclusions to steel. The main process methods include: (1) control of inclusions in converter smelting, including \textcircled{1} reducing supplementary blowing and reducing the amount of slag as much as possible to reduce the oxygen content at the end of the converter; \textcircled{2} increasing the MgO content and alkalinity of the final slag of the converter to reduce the amount of slag; \textcircled{3} tapping slag blocking, slag removal and slag denaturation; \textcircled{4} during the converter tapping process, slag washes out sulfur, reduces the sulfur content of molten steel, and suppresses the hazards of sulfide inclusions. (2) Control of inclusions in the refining process, including ladle blowing argon, tundish air curtain retaining wall, pressurization and decompression method (NK-PERM), ladle electromagnetic stirring, tundish centrifugal separation, crystallizer electromagnetic braking, calcium processing technology, etc.

Elements that can spheroidize oxides, sulfides or oxysulfides include the following: calcium, tellurium, magnesium, rare earths, etc. The solid solubility of the above four elements of calcium, tellurium, magnesium and rare earth in the matrix iron is very low. The reason why these elements can spheroidize the sulfides is that the sulfides of these elements have low wettability to the steel matrix, high interface energy, and large contact angle, so they are spherical.

However, the above-mentioned methods have different disadvantages: (1) for calcium-treated steel: the addition of calcium is more complicated: one is to add calcium into molten steel by spraying a spray gun in the ladle; and the other is to add calcium using a core steel wire feeding method. (2) For steel treated with tellurium and selenium: \textcircled{1} the price of these two elements is very high, which is unpopular from economic considerations; \textcircled{2} both are toxic; \textcircled{3} tellurium can also cause hot embrittlement during rolling. (3) For magnesium-treated steel: since magnesium is very light, it is difficult to add into molten steel alone, and the yield is low. (4) For rare earth-treated steel: \textcircled{1} during the production and application of rare earths, radioactive dust is likely to be generated, and the resulting radioactive hazards cannot be ignored. \textcircled{2} Nodules are easy to form at the nozzle when the rare earth treated steel is poured. When deoxidizing with a strong deoxidizer such as A1, the problem of nodulation at the nozzle often occurs. \textcircled{3} Rare earth inclusions have a large specificity, generally between 5.5 and 6.5, and are not easy to float, especially when the amount of rare earth added is excessive, it will increase harmful inclusions in steel, especially large-sized inclusions, and even produce brittle rare earth and iron metal compounds, deteriorating the performance of steel.

From the above analysis, it can be seen that whether it is the control of inclusions in converter smelting or in the refining process, the process is complicated, involving many process links, and the equipment investment cost is high, making the control difficult. In view of this, the present invention provides a composite additive for forming inclusions with a core-shell structure, a preparation method and a smelting method.

### SUMMARY

The technical problem to be solved by the present invention is to provide a composite additive for forming inclusions with a core-shell structure, a preparation method and a smelting method. The objective is to provide a low-cost, simple process for forming inclusions with a core-shell structure, which has the characteristics of fineness, spheroidization and dispersion effect, and can significantly improve the plasticity, toughness, fatigue resistance, local corrosion resistance, welding performance and cold bending performance of steel materials.

In order to solve the above technical problems, the present invention provides a composite additive for forming inclusions with a core-shell structure in a first aspect, which includes the following chemical components by mass percentage: Fe: 41-59%, Zr: 5-11%, Ti: 14-26%, Mg: 11-19%, RE: 4-10%. The mass percentage content of Zr element, Ti element, Mg element and RE element satisfies a formula: (Ti+Mg+RE)/Zr=4-8.

The functions of the above components in the composite additive are as follows:

Zirconium: Zirconium is a commonly used deoxidizer, and because it is often used for deoxidization together with titanium or aluminum titanium, it forms fine and dispersed complex inclusions. The complex inclusions pin the grain boundary movement during the welding thermal cycle to limit the austenite grain growth, and induce acicular ferrite nucleation during the austenite transformation process, so that the grains are effectively refined and the toughness of the welded coarse-grained zone is improved. At the same time, zirconium is a strong carbide-forming element, and its effect in steel is similar to that of niobium, vanadium, and titanium, forming carbides or nitrides, which can effectively refine the grains and benefit the low-temperature properties of steel. But excessive zirconium will also cause coarse particles and lose the effect of inhibiting grain coarsening. The mass content of Zr in the present invention is 5-11 wt %.

Titanium: Titanium has a very strong affinity with oxygen, nitrogen, and carbon, and is a good deoxidizer and an effective element for fixing nitrogen and carbon. Titanium oxides are considered to be the most effective nucleation inclusions in steel, and can effectively promote the nucleation of acicular ferrite, which is widely used in oxide metallurgy. Titanium can form fine and dispersed TiN particles in steel, which can be slowly dissolved when heated to above 1400° C. in steel. In the process of welding heat cycle TiN particles can effectively hinder the coarsening of austenite grains, which is beneficial to the improvement of toughness. TiN particles can effectively promote the formation of acicular ferrite and effectively improve the welding performance of steel. But excessive Ti is not conducive to improving the performance of steel, and it is easy to form coarse carbonitrides of titanium, which become the source of cracks, resulting in reduced toughness. Therefore, the mass content of Ti in the present invention is 14-26 wt %.

Magnesium: Magnesium is a strong deoxidizing element and a complex oxysulfide forming element. Magnesium enables reduction in the number and size, uniform distribution, and shape improvement of inclusions in steel. Trace amounts of magnesium can improve the size and distribution of carbides in stainless steel. The particles are fine and uniform, and the formed MgO inclusions have the effect of pinning the austenite grain boundary, and have a good control effect on the grain size. Therefore, the mass content of Mg in the present invention is 11-19 wt %.

Rare earth: In iron and steel materials, it can be used as a deoxidizer, especially lanthanum (La) and cerium (Ce). When they are added into molten steel, the extremely active rare earth elements can be combined with O, S, etc. in steel to form extremely stable oxides, sulfides, and oxysulfides. The addition of rare earth elements significantly improves the mechanical properties and corrosion resistance of steel materials, and rare earth steels have also become a research hotspot for a time and are used to develop steel material that meet specific needs. Therefore, the mass content of RE in the present invention is 4-10 wt %.

It should be noted that, in the above formula (Ti+Mg+RE)/Zr, Ti, Mg, RE and Zr respectively represent their respective mass percentages, and the value substituted into the above formula is the value before the percentage sign. For example, the mass percentage of Ti is 20%, the mass percentage of Mg is 15%, the mass percentage of RE is 7%, and the mass percentage of Zr is 8%, then they are substituted into the above formula (Ti+Mg+RE)/Zr=(20+15+7)/8=5.2.

The beneficial effects of the present invention are:

(1) The composite additive according to the present invention has the advantages of low cost, simple process, formed inclusions with core-shell structure, fineness, spheroidization and obvious dispersion effect, and can significantly improve the plasticity, toughness, fatigue resistance, local corrosion resistance, welding performance, cold bending performance, etc. of steel materials.

(2) The composite additive according to the present invention is suitable for steel for marine engineering, steel for pipeline containers, steel for cryogenic containers, steel for bridges, steel for iron towers, steel for rails, steel for bearings, steel for gears, steel for shield machine tools, cord steel, spring steel, cold heading steel, automobile steel, electrical steel and other steels that have strict requirements on the shape of inclusions. The obtained inclusions are complex inclusions with a core-shell structure that are fine, spheroidized, dispersed, and have a bulk modulus similar to that of the iron matrix. It can significantly improve the corrosion resistance of neutral water medium, seawater corrosion resistance, fatigue resistance, plasticity and toughness, and reduce local stress concentration.

On the basis of the above technical solutions, the present invention can also be improved as follows.

Further, it includes the following chemical components by mass percentage: Fe: 46-57%, Zr: 6-11%, Ti: 15-16%, Mg: 12-19%, and RE: 9-10%.

Further, it includes the following chemical composition by mass percentage: Fe: 50%, Zr: 8%, Ti: 20%, Mg: 15%, and RE: 7%.

Further, the RE includes La element and Ce element, and the mass ratio of the La element to the Ce element is (70-90):(10-30).

Further, the Zr is sponge metal zirconium and/or metal zirconium; the Mg is any one or a combination of at least two of metallic magnesium lumps, magnesium grains, magnesium-zirconium alloy lumps, and magnesium-zirconium alloy grains.

In a second aspect, the present invention provides a method for preparing a composite additive for forming inclusions with a core-shell structure. The method includes the steps of: first adding Zr, Ti and RE to Fe—Ti alloy, then melting in a vacuum induction furnace, and then casting under vacuum conditions to obtain a composite additive.

Further, the melting time in the vacuum induction furnace in the preparation method is 4-8 hours.

In a third aspect, the present invention provides a smelting method. The smelting method includes the steps of:
(1) after steelmaking molten iron and/or scrap steel using a converter or an electric arc furnace, adjusting the temperature and composition to obtain molten steel;
(2) making the molten steel enter a ladle, first performing pre-deoxidation, and then performing final deoxidation using any one of the above-mentioned composite additives to obtain final deoxidized molten steel; and
(3) refining and continuously casting the final deoxidized molten steel in sequence.

Further, the temperature of the molten steel in the step (1) is 1551-1690° C., and the free oxygen content in the molten steel is 101-399 ppm. The step (2) includes: making the molten steel enter the ladle, pre-deoxidizing the molten steel with Fe—Si alloy or Fe—Si—Mo alloy in the ladle under micro-subbubble stirring, and adjusting the free oxygen content in the molten steel to 11-99 ppm, and then under micro-subbubble stirring, performing final deoxidation using a composite additive to obtain final deoxidized molten steel. In step (3), the final deoxidized molten steel is firstly subjected to ladle furnace (LF) refining, vacuum degassing (VD) refining, or Ruhrstahl-Heraeus (RH) refining, and then continuous casting.

Further, in step (2), the amount of the composite additive added per ton of the molten steel is 0.51-4.9 kg. The composite additive is added into the molten steel in the form of bulk alloy or cored wire, and the particle size of the composite additive is 3-19 mm.

### BRIEF DESCRIPTION OF THE DRAWINGS

FIG. 1 shows morphology of inclusions in low-alloy high-strength steel obtained after non-aqueous solution electrolytic extraction according to the present invention;

FIG. 2 shows element distribution of the inclusions in the low-alloy high-strength steel obtained after non-aqueous solution electrolytic extraction according to the present invention;

FIGS. 3A-3B show SEM morphology and EDS analysis of inclusions in conventional Al deoxidized steel low-alloy high-strength steel after electrolytic extraction according to the present invention;

FIG. 4 shows precipitation curves of particles such as sulfide and nitride in a solidification process according to the present invention;

FIGS. 5A-5C show the density of states of different oxides, in which FIG. 5A represents the density of state of Ti₂O₃, FIG. 5B represents the density of state of ZrO₂, and FIG. 5C represents the density of state of Al₂O₃, and the dotted line is Fermi surface, according to the present invention;

FIGS. 6A-6B show KAM test results after complex deoxidation of rare earth La, in which FIG. 6A represents an IQ map, and FIG. 6B represents a KAM map, according to the present invention; and

FIGS. 7A-7C show Young's moduli of Fe matrix, Al₂O₃, and AlLaO₃ inclusions, in which FIG. 7A represents Fe matrix, FIG. 7B represents Al₂O₃, and FIG. 7C represents AlLaO₃, according to the present invention.

### DETAILED DESCRIPTION OF THE EMBODIMENTS

The principles and features of the present invention are described below, and the examples given are only used to explain the present invention, and are not intended to limit the scope of the present invention. If no specific technique or condition is indicated in the examples, it shall be carried out according to the technique or condition described in the literature in the art, or according to the product specification. The reagents or instruments used were not indicated by the manufacturer, and they were all conventional products that can be purchased through formal channels.

### Example 1

This example relates to a composite additive for forming inclusions with a core-shell structure, which includes the following chemical components by mass percentage: Fe of 50 wt %. Zr of 8 wt %, Ti of 20 wt %, Mg of 15 wt %, and RE of 7 wt %, with the rest being unavoidable impurities. The mass percent content of Zr element, Ti element, Mg element and RE element satisfies a formula: (Mg+Ti+RE)/Zr=5.2. The RE includes La element and Ce element. The mass ratio of the La element to the Ce element is 80:20.

This example relates to a method for preparing a composite additive for forming inclusions with a core-shell structure, which includes the following steps: based on Fe—Ti alloy, adding Zr, Ti and RE, wherein the RE includes lanthanum La and cerium Ce, and La accounts for 80%, and Ce accounts for 20%, smelting in a vacuum induction furnace for 6 hours, and casting under vacuum conditions. The Zr used in the composite additive is sponge metal Zr or metal Zr. The RE used in the composite additive is mixed rare earth, including lanthanum La and cerium Ce. La accounts for 80%, and Ce accounts for 20%. The Mg used in the composite additive is metal magnesium block, magnesium grain, Mg—Zr alloy block, or Mg—Zr alloy grain. This example relates to a smelting method, which includes the following steps:
(1) after steelmaking molten iron, or scrap steel, or molten iron and scrap steel using a converter (BOF) or electric are furnace (EAF), adjusting the temperature and composition of the molten steel, in which the tapping temperature is adjusted to 1620° C., and the free oxygen content in the molten steel is 250 ppm;
(2) stirring the molten steel for 6 minutes with fine agron bubbling after entering a ladle, then performing pre-deoxidation using Fe—Si alloy or Fe—Si—Mn alloy in the ladle, adjusting the free oxygen content in the molten steel to 55 ppm, and after micro-subbubble stirring for 4 minutes, performing final deoxidation with a composite additive, in which the composite additive is added into the molten steel in the form of bulk alloys or cored wires, the particle size of the composite additive is 11 mm, and the amount of the composite additive added is 2.7 kg per ton of molten steel; and obtaining molten steel after final deoxidation; and
(3) then performing LF refining, VD refining, or RH refining on the obtained molten steel after final deoxidation according to a conventional process; and finally, continuously casting the refined molten steel according to a conventional process.

### Example 2

This example relates to a composite additive for forming inclusions with a core-shell structure, which includes the following chemical components by mass percentage: Fe of 46 wt %. Zr of 11 wt %, Ti of 15 wt %, Mg of 19 wt %, and RE of 10 wt %, with the rest being unavoidable impurities. The mass percent content of Zr element, Ti element, Mg element and RE element satisfies a formula: (Mg+Ti+RE)/Zr=4. The RE includes La element and Ce element. The mass ratio of the La element to the Ce element is 90:10.

This example relates to a method for preparing a composite additive for forming inclusions with a core-shell structure, which includes the following steps: based on Fe—Ti alloy, adding Zr, Ti and RE, in which the RE includes lanthanum La and cerium Ce, La accounts for 90%, and Ce accounts for 10%, smelting in a vacuum induction furnace for 4 hours, and casting under vacuum conditions. The Zr used in the composite additive is sponge metal Zr or metal Zr. The RE used in the composite additive is mixed rare earth, including lanthanum La and cerium Ce. La accounts for 90%, and Ce accounts for 10%. The Mg used in the composite additive is metal magnesium block, magnesium grain, Mg—Zr alloy block, or Mg—Zr alloy grain.

This example relates to a smelting method, which includes the following steps:
(1) after steelmaking molten iron, or scrap steel, or molten iron and scrap steel using a converter or electric arc furnace, adjusting the temperature and composition of the molten steel, in which the tapping temperature is adjusted to 1560° C., and the free oxygen content in the molten steel is 150 ppm;
(2) stirring the molten steel for 5 minutes with fine agron bubbling after entering a ladle, then performing pre-deoxidation using Fe—Si alloy or Fe—Si—Mn alloy in the ladle, adjusting the free oxygen content in the molten steel to 20 ppm, and after micro-subbubble stirring for 3 minutes, performing final deoxidation with a composite additive, in which the composite additive is added into the molten steel in the form of bulk alloys or cored wires, the particle size of the composite additive is 3-19 mm, and the amount of the composite additive added is 0.70 kg per ton of molten steel; and obtaining molten steel after final deoxidation; and
(3) then performing LF refining. VD refining, or RH refining on the obtained molten steel after final deoxidation according to a conventional process; and finally, continuously casting the refined molten steel according to a conventional process.

### Example 3

This example relates to a composite additive for forming inclusions with a core-shell structure, which includes the following chemical components by mass percentage: Fe of 57 wt %, Zr of 6 wt %, Ti of 16 wt %, Mg of 12 wt %, and RE of 9 wt %, with the rest being unavoidable impurities. The mass percent content of Zr element, Ti element, Mg element and RE element satisfies a formula: (Mg+Ti+RE)/Zr=6.2. The RE includes La element and Ce element. The mass ratio of the La element to the Ce element is 70:30.

This example relates to a method for preparing a composite additive for forming inclusions with a core-shell structure, which includes the following steps: based on Fe—Ti alloy, adding Zr, Ti and RE, in which the RE includes lanthanum La and cerium Ce, La accounts for 70%, and Ce accounts for 30%, smelting in a vacuum induction furnace for 7 hours, and casting under vacuum conditions. The Zr used in the composite additive is sponge metal Zr or metal Zr. The RE used in the composite additive is mixed rare earth, including lanthanum La and cerium Ce. La accounts for 70%, and Ce accounts for 30%. The Mg used in the composite additive is metal magnesium block, magnesium grain, Mg—Zr alloy block, or Mg—Zr alloy grain.

This example relates to a smelting method, which includes the following steps:
(1) after steelmaking molten iron, or scrap steel, or molten iron and scrap steel using a converter or electric arc furnace, adjusting the temperature and composition of the molten steel, in which the tapping temperature is adjusted to 1670° C., and the free oxygen content in the molten steel is 350 ppm;
(2) stirring the molten steel for 8 minutes with fine agron bubbling after entering a ladle, then performing pre-deoxidation using Fe—Si alloy or Fe—Si—Mn alloy in the ladle, adjusting the free oxygen content in the molten steel to 80 ppm, and after micro-subbubble stirring for 5 minutes, performing final deoxidation with a composite additive, in which the composite additive is added into the molten steel in the form of bulk alloys or cored wires, the particle size of the composite additive is 16 mm, and the amount of the composite additive added is 3.9 kg per ton of molten steel; and obtaining molten steel after final deoxidation; and
(3) then performing LF refining, VD refining, or RH refining on the obtained molten steel after final deoxidation according to a conventional process; and finally, continuously casting the refined molten steel according to a conventional process.

### Experimental Example

Below in conjunction with the low-alloy high-strength steel prepared in Example 1, the main features of its inclusions are observed, analyzed and tested, and the results are as follows:

### (1) Features of Core-Shell Structure of Inclusions

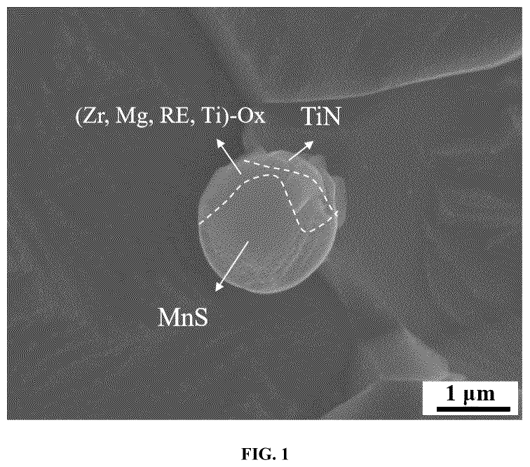

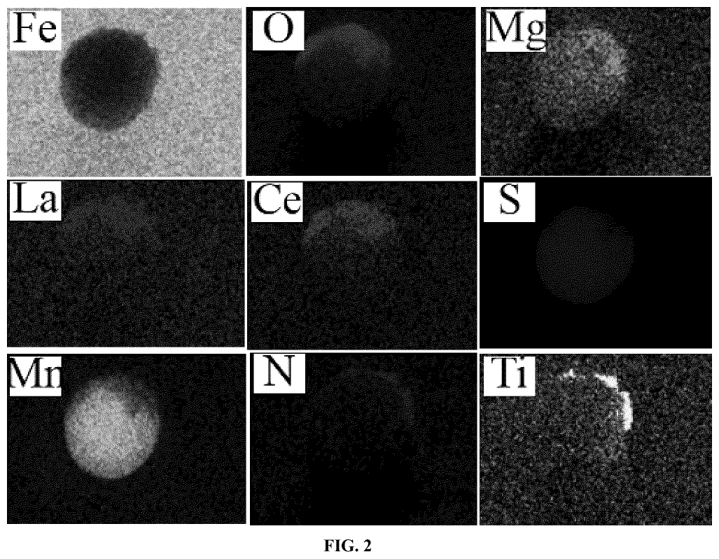

FIGS. 1 and 2 show a morphology diagram and an element distribution diagram of inclusions in low-alloy high-strength steel obtained after non-aqueous solution electrolytic extraction. It can be seen from FIGS. 1 and 2 that the morphology of the inclusions is spherical. The type of inclusions extracted by non-aqueous solution electrolysis is complex oxysulfide, in which the core of the inclusions is Zr, Ti, Mg, RE complex oxide, and the surface of the spherical particles is sulfide (MnS) and carbide (TIN).

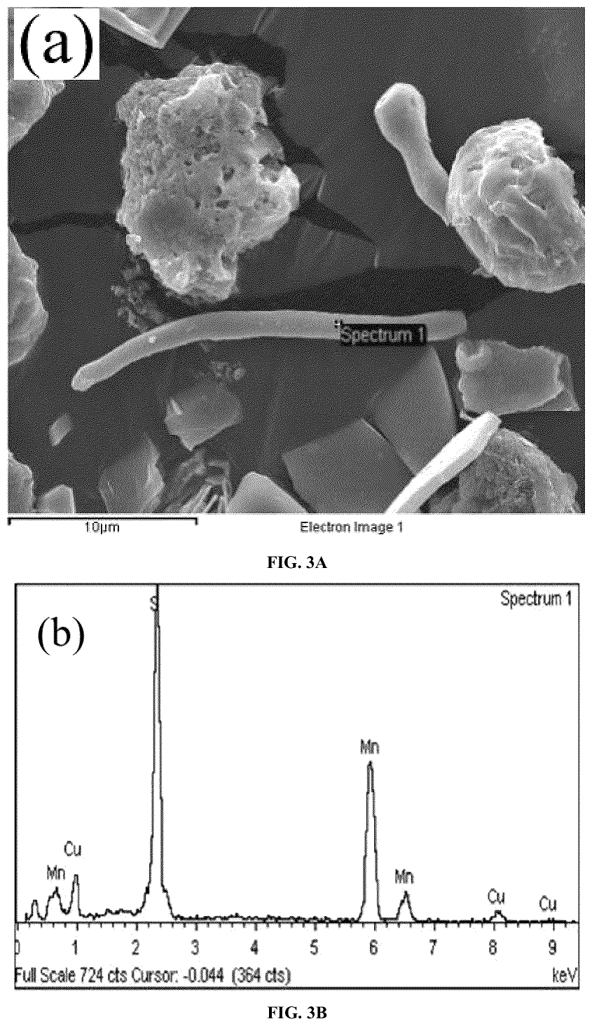

The types and sizes of inclusions in low-alloy high-strength steel added with different amounts of composite additives were compared by scanning electron microscopy. In conventional Al-deoxidized steel, the oxide inclusions are clustered (reference: Deng Z, Zhu M. Evolution Mechanism of Non-metallic Inclusions in Al-Killed Alloyed Steel during Secondary Refining Process [J].Isij International, 2013, 53(3):450-458.), the sizes of inclusions are mainly concentrated in 2-5 μm, and the sulfide is in the form of strips, usually 5-20 μm in length; and after complex deoxidation treatment, the sizes of inclusions are obviously refined, mainly concentrated in 1-3 μm (as shown in FIGS. 3A-3B).

### (2) Complex Deoxidation Thermodynamics

In the above experimental example (1), the inclusions were observed and analyzed. The inclusions are core-shell structures with sulfur oxides as the core and nitrides and sulfides attached to the periphery. This part is about the formation of complex inclusions and evolution for thermodynamic analysis. Considering the diversity of alloying elements in steel, a series of physical and chemical reactions will occur in the process of steelmaking and molten steel solidification to form non-metallic inclusions such as oxides, sulfides and nitrides. The Gibbs free energy change is the criteria to determine whether the reaction can proceed spontaneously under constant temperature and pressure, and ΔG<0 indicates that the reaction can occur spontaneously. The deoxidation reaction equation and thermodynamic formula involved in adding alloying elements into molten steel are shown in formulas (1) and (2).

$$\frac{X}{y} [ M ] + [ O ] = \frac{1}{y} ( {M}_{x} {O}_{y} ) \qquad ( 1 )$$

$$Δ G = Δ {G}^{θ} + RT ln K = Δ {G}^{θ} + RT ln \frac{{a}_{{M}_{x} {O}_{y}}^{1 / y}}{{a}_{[ O ]} {a}_{[ M ]}^{x / y}} \qquad ( 2 )$$

In the formula, ΔG and ΔG^{θ} represent the Gibbs free energy and standard Gibbs free energy of the reaction (J/mol), respectively. R is the gas constant, (J/(mol·K)), T is the temperature, (K), and aᵢ represents the activity of the element. Table 1 gives the corresponding Gibbs free energy data of inclusion formation that may be involved in low-alloy high-strength steel, and the molten steel temperature is set to 1873 K. As shown in Table 1, according to the Gibbs free energy value, the formation order of pure metal oxides is Al₂O₃ (−734.33 KJ/mol). La₂O₃ (−610.85 KJ/mol), Ti₂O₃ (−273.72 KJ/mol), ZrO₂ (−156.09 KJ/mol), and CaO (−96.36 KJ/mol). In addition, Zr and RE can completely or partially replace Al elements in Al₂O₃ in molten steel to form ZrO₂ (−7298.12 KJ/mol) and LaAlO₃ (−646.15 KJ/mol). Ca element can react with molten aluminum and oxygen to form calcium aluminate (−9458.40 KJ/mol). In traditional aluminum deoxidation techniques used in steelmaking, Al₂O₃ dominates the inclusions. At the same time, refractory bricks are easy to react with Al₂O₃ to form Al₂O₃·MgO (similar to spinel).

TABLE 1
Gibbs free energy of inclusion formation reaction at 1873 K

| No. | Chemical reaction | ΔG^{θ} (J/mol) | | ΔG (KJ/mol) |
|---|---|---|---|---|
| 1 | 2[Al] + 3[O] = (Al₂O₃) | −1682927 + | 323.240T | −734.33 |
| 2 | [Mg] + 2[Al] + 4[O] = (MgO•Al₂O₃) | −1848696 + | 574.144T | ΔG^{θ} = −773.32 |
| 3 | [Zr] + 2[O] = (ZrO₂) | −845532 + | 266.100T | −156.09 |
| 4 | 2[Ti] + 3[O] = (Ti₂O₃) | −1072872 + | 346.000T | −273.72 |
| 5 | [Ca] + [O] = (CaO) | −138227 − | 63.000T | −96.36 |
| 6 | [Ca] + 6[Al] + 4[O] = [CaO•Al₂O₃] | −1023637 + | 142.120T | −9458.40 |
| 7 | 2[La] + 3[O] = (La₂O₃) | −542531 + | 124.150T | −610.85 |
| 8 | 3[Zr] + 2(Al₂O₃) = 4[Al] + 3(ZrO₂) | −8233279 + | 464.510T | −7298.12 |
| 9 | 3[Zr] + 2(Ti₂O₃) = 4[Ti] + 3(ZrO₂) | −1073389 + | 538.830T | −11.99 |
| 10 | [La] + 3[O] + [Al] = (LaAlO₃) | −801616 + | 129.000T | −646.15 |
| 11 | [Ce] + (Al₂O₃) = (CeAlO₃) + [Al] | −423900 − | 247.300T | −833.13 |
| 12 | [Ca] + [S] = (CaS) | −542531 + | 124.150T | −126.03 |
| 13 | [Ti] + [N] = (TiN) | −307620 + | 113.400T | 65.09 |

Zr, Ti, Mg, RE (rare earth) elements are used for complex deoxidation, and complex sulfur oxides are easily formed in molten steel. Taking Zr, La, Ce alloy elements as examples, thermodynamic calculations were carried out (Formula 3-6). The results show that Zr can directly react with Ti₂O₃ and Al₂O₃ (Formula 3 and 4), and the complex addition of Zr and Ti deoxidizing elements will lead to a uniform distribution of Zr and Ti complex oxides in molten steel. This provides theoretical support for the addition of Zr to modify common inclusions in steel (such as Al₂O₃). Formula 5 and 6 show that under low oxygen concentration, RE elements can directly react with Al in molten steel to form (La, Ce)—AlO₃.

$$\begin{matrix}3 [ Zr ] + 2 ( A {1}_{2} {O}_{3} ) = 4 [ A 1 ] + 3 ( {ZrO}_{2} ) \\ Δ {G}_{1} = Δ {G}_{1}^{θ} + RT ln {J}_{1} = - 8233279 + 464.51 T + RT ln \frac{{a}_{( {ZrO}_{2} )}^{3} \cdot {a}_{[ A 1 ]}^{4}}{{a}_{( A {1}_{2} {O}_{3} )}^{2} \cdot {a}_{[ Zr ]}^{3}}\end{matrix} \qquad ( 3 )$$

$$\begin{matrix}3 [ Zr ] + 2 ( {Ti}_{2} {O}_{3} ) = 4 [ Ti ] + 3 ( {ZrO}_{2} ) \\ Δ {G}_{2} = Δ {G}_{2}^{θ} + RT ln {J}_{2} = - 1073389 + 538.83 T + RT ln \frac{{a}_{( {ZrO}_{2} )}^{3} \cdot {a}_{[ Ti ]}^{4}}{{a}_{( {Ti}_{2} {O}_{3} )}^{2} \cdot {a}_{[ Zr ]}^{3}}\end{matrix} \qquad ( 4 )$$

$$\begin{matrix}[ La ] + 3 [ {O}_{3} ] + [ A 1 ] = LaA 1 {O}_{3} ( s ) \\ Δ {G}_{3} = Δ {G}_{3}^{θ} + RT ln {J}_{3} = - 801616 + 129 T + RT ln \frac{{a}_{( LaA 1 {O}_{3} )}}{{a}_{( La )} \cdot {a}_{[ O ]}^{3} \cdot {a}_{[ A 1 ]}}\end{matrix} \qquad ( 5 )$$

$$\begin{matrix}[ Ce ] + ( A {1}_{2} {O}_{3} ) = CeA 1 {O}_{3} ( s ) + [ A 1 ] \\ Δ {G}_{4} = Δ {G}_{4}^{θ} + RT ln {J}_{3} = - 423900 - 247.3 T + RT ln \frac{{a}_{( CeA 1 {O}_{3} )} \cdot {a}_{[ A 1 ]}}{{a}_{( A {1}_{2} {O}_{3} )} \cdot {a}_{[ Ce ]}}\end{matrix} \qquad ( 6 )$$

ΔG and ΔG^{θ}, (J/mol) represent Gibbs free energy and standard Gibbs free energy, R is a constant, (J/(mol·k)), T represents temperature, (K), aᵢ represents the activity of element I, and J₁, J₂, J₃, and J₄ represent

$$\frac{{a}_{( {ZrO}_{2} )}^{3} \cdot {a}_{[ A 1 ]}^{4}}{{a}_{( A {1}_{2} {O}_{3} )}^{2} \cdot {a}_{[ Zr ]}^{3}} , \frac{{a}_{( {ZrO}_{2} )}^{3} \cdot {a}_{[ Ti ]}^{4}}{{a}_{( {Ti}_{2} {O}_{3} )}^{2} \cdot {a}_{[ Zr ]}^{3}} , \frac{{a}_{( LaA 1 {O}_{3} )}}{{a}_{( La )} \cdot {a}_{[ O ]}^{3} \cdot {a}_{[ A 1 ]}} , and \frac{{a}_{( CeA 1 {O}_{3} )} \cdot {a}_{[ A 1 ]}}{{a}_{( A {1}_{2} {O}_{3} )} \cdot {a}_{[ Ce ]}} ,$$

respectively. In the example low-alloy high-strength steel, the melting temperature is set to 1873 K, and the corresponding Gibbs free energies are −7298.12 kJ/(mol·K), −11.99 KJ/(mol·K), −646.152 kJ/(mol·K), and −833.13 KJ/(mol·K), in which all Gibbs free energies are negative, indicating that all reactions can proceed spontaneously.

### (3) Formation Mechanism of Complex Sulfur Oxides

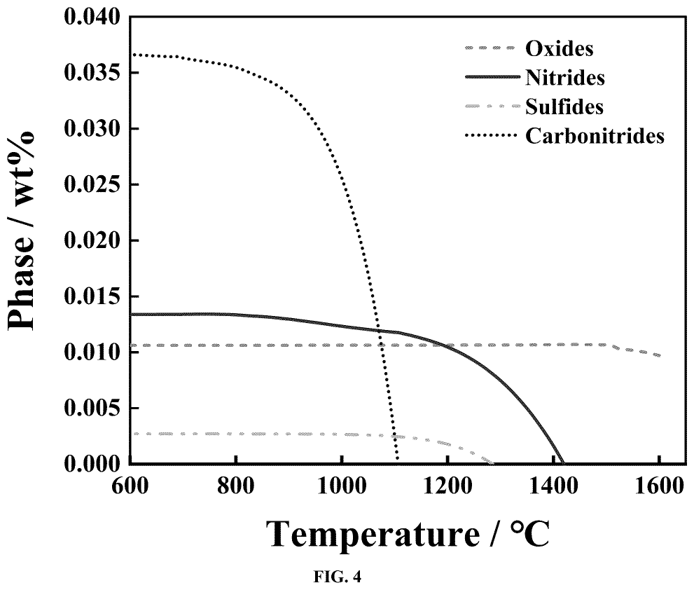

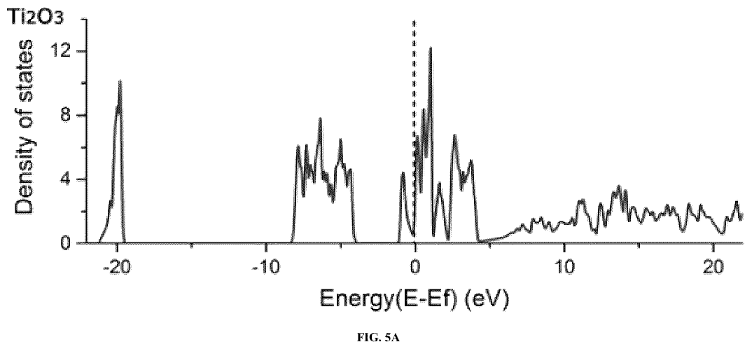

Table 2 shows the solid solubility product formulas of carbides, nitrides, and sulfides. FIG. 4 shows precipitation curves of molten steel during solidification and cooling calculated using JMatPro thermodynamic software. It can be seen from FIG. 4 that nitrides start to precipitate and grow at around 1400° C., and sulfides start to precipitate and grow at around 1300° C. Carbonitrides start to precipitate at a low temperature of about 1100° C. In the later stage of the solidification process, CaS and TiN mainly precipitate on the surface of the pre-formed oxide inclusions. Therefore, after complex deoxidation of Zr, Ti, Mg, and RE (rare earth) elements, the molten steel is continuously cast or die-cast, and then rolled to obtain the complex inclusions with a core-shell structure as shown in FIG. 1.

TABLE 2
Solid solubility product formulas of carbides, nitrides, and sulfides

| No. | Precipitation phase | Solid solubility product formula |
|---|---|---|
| 1 | NbC | lg{[Nb] · [C]} = 2.26-6770/T |
| 2 | NbN | lg{[Nb] · [N]} = 2.80-8500/T |
| 3 | TiC | lg{[Ti] · [C]} = 2.75-7000/T |
| 4 | TiN | lg{[Ti] · [N]} = 0.32-8000/T |
| 5 | MnS | lg{[Mn] · [S]} = 5.02-11625/T |

MnS and ZrO₂ have very similar lattice constants, see Table 3 for specific data. Since MnS and ZrO₂ have a good lattice matching relationship, this will reduce the interfacial energy between the two. Lower interfacial energy leads to better adhesion between grains at different interfaces. This further proves the reason why strips and strings of sulfides were not formed in the test samples. This is because MnS tends to precipitate on the pre-formed ZrO₂ particles, and the sulfides are thus refined, spheroidized and dispersed. Thus, it is beneficial to improve the plasticity and toughness of Zr and Mg complex deoxidized ferritic stainless steel.

TABLE 3
Lattice constants of MnS and ZrO₂

| | Crystal | Planes | Plane | | | | | | | | |
|---|---|---|---|---|---|---|---|---|---|---|---|
| Category | structure | (hkl) | distance | β | int | h | k | l | a | b | c |
| ZrO₂ | Monoclinic | 002 | 2.621 | 99.23 | 20 | 0 | 0 | 2 | 5.145 | 5.207 | 5.311 |
| | | 022 | 1.847 | | 14 | 0 | 2 | 2 | | | |
| | | 113 | 1.509 | | 4 | 1 | 1 | 3 | | | |
| MnS | Fcc | 111 | 2.612 | 90 | 100 | 1 | 1 | 1 | 5.224 | 5.224 | 5.224 |
| | | 220 | 1.847 | | 50 | 2 | 2 | 0 | | | |
| | | 222 | 1.509 | | 20 | 2 | 2 | 2 | | | |

### (4) Fine Dispersion Mechanism of Complex Deoxidized Inclusions

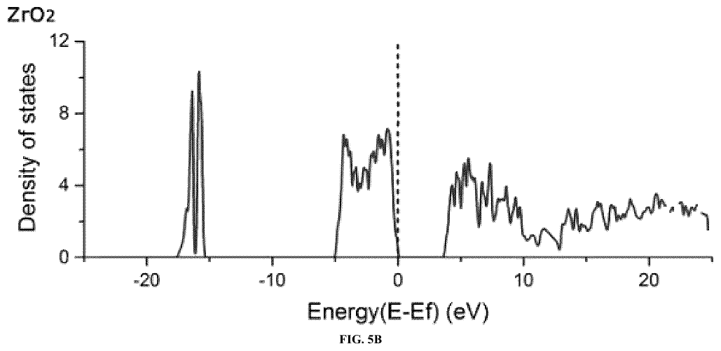

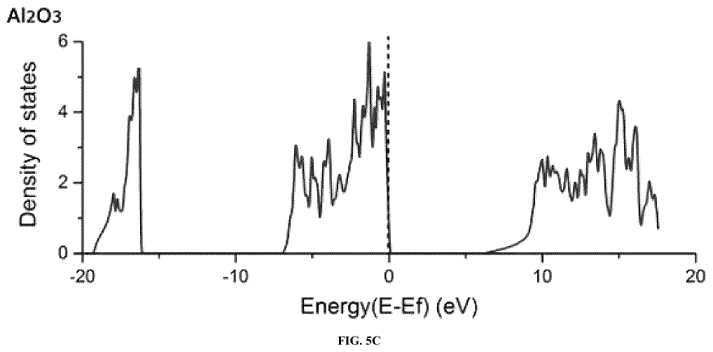

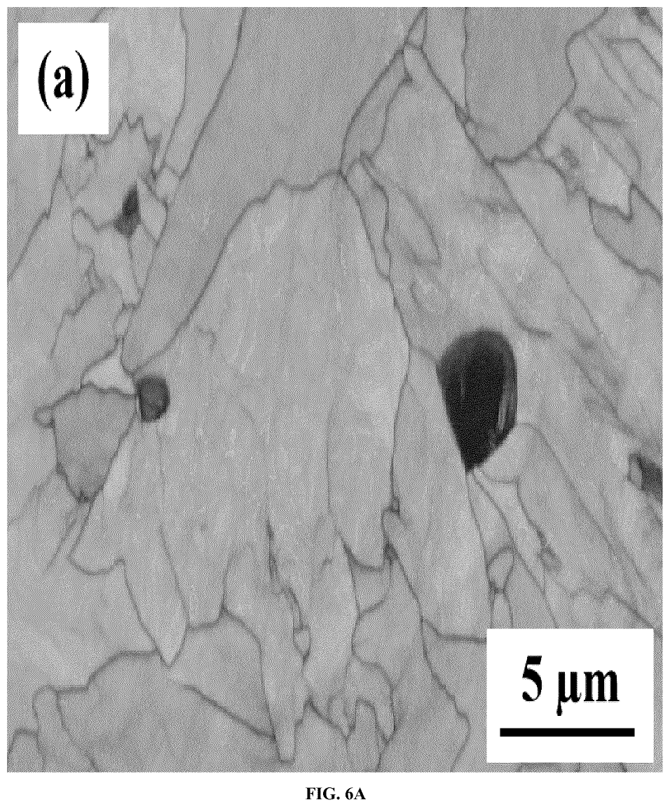

Density of states (DOS) is a useful tool for analyzing the electronic structure of solids. The DOS of the oxide is shown in FIGS. 5A-5C. For Ti₂O₃, there is no gap at the Fermi surface, indicating that it is metallic. For ZrO₂ and Al₂O₃, the interstitial energies at the Fermi surface are 3.5 eV and 6.3 eV, respectively. The larger the interstitial energy, the stronger the insulation of the material. At 1273 K, the electrical conductivities of Ti₂O₃, ZrO₂ and Al₂O₃ are 10² Ω⁻¹m⁻¹, 10⁻¹ Ω⁻¹m⁻¹ and 10⁻² Ω⁻¹m⁻¹, respectively. The DOS data is consistent with the conductivity data in the literature (Zhang X, Qin R. Controlled motion of electrically neutral microparticles by pulsed direct current[J]. 2015, 5:10162.).

The conductivity of oxides is a key factor for their movement in molten steel. According to the existing research results, the driving force of Al₂O₃ movement in molten steel is greater than the driving force of ZrO₂ movement. During refining and electrification, ZrO₂ particles tend to repel each other and are difficult to agglomerate, while Al₂O₃ tends to collide with each other to form large particles, which float over the surface of molten steel and are absorbed by the surface covering agent of molten steel. Therefore, compared with conventional Al deoxidation, fine and dispersed complex oxides can be formed by Zr, Ti, Mg, RE complex deoxidation, which is proved by the experimental results in FIGS. 1 and 2.

According to the basic principles of metallurgical thermodynamics, Zr, Ti, Mg, and RE are all strong oxide-forming elements, and the use of Zr, Ti, Mg, and RE for complex deoxidation is beneficial to the removal of free oxygen content in molten steel. Density of main oxides in steel is shown in Table 4. It can be seen from Table 4 that the density of ZrO₂ is 5.68 g/cm³, which is greater than that of Al₂O₃ (3.97 g/cm³), especially the density of ZrO₂ is closer to that of molten steel (7.15 g/cm³). Rare earth oxides have a density greater than that of ZrO₂ (6.87 g/cm³), so the addition of rare earths makes the density of the complex oxides closer to that of molten steel. Therefore, once stable oxides are formed at high temperatures, the complex oxides mainly composed of ZrO₂ and rare earth oxides can float evenly in molten steel, while Al₂O₃ will collide and gather on the surface of molten steel to become a component of steel slag. The unfloating part of Al₂O₃ will remain in the steel as clusters of large inclusions.

TABLE 4
Densities of molten steel and various inclusions

| Inclusions | Ce₂O₃ | Al₂O₃ | ZrO₂ | Ti₂O₃ | TiO₂ | CaO | FeO | MnO | MnO₂ |
|---|---|---|---|---|---|---|---|---|---|
| Density | 6.87 | 3.97 | 5.68 | 4.48 | 4.23 | 3.34 | 5.75 | 5.37 | 5.03 |
| (g/cm³) | | | | | | | | | |
| Inclusions | MgO | SiO₂ | Fe₂O₃ | CaS | MnS | MgS | FeS | TiN | AlN |
| Density | 3.58 | 2.65 | 5.24 | 2.59 | 4.89 | 2.80 | 4.85 | 5.22 | 3.26 |

(5) The Physical Mechanism that the Bulk Modulus of Inclusions is Close to that of Iron Matrix

Table 5 shows the crystal structure of the selected iron matrix and inclusions, and Table 6 shows the physical properties of the relevant inclusions determined in combination with first-principle calculations. According to the calculation results, the bulk moduli of LaAlO₃ (192.61) and La₂O₇Zr₂ (165.83) are lower than those of Al₂O₃ (249.54) and ZrO₂ (271.06), and the bulk modulus of LaAlO₃ (192.61) is closer to that of the iron matrix (194.76). Other inclusions, such as CaO (114.11), MgO (165.84), TiN (175.02) and CaS (57.05), exhibit a lower bulk modulus than the matrix.

TABLE 5
Crystal structure parameters of inclusions and BCC matrix

| | | | Lattice parameters |
|---|---|---|---|
| | Space group | Atomic position | (Å/°) |
| Fe (BCC) | Im-3m (229) | Fe (0.00000, 0.00000, 0.00000) | a = b = c = 2.8336 |
| | | | α = β = γ = 90° |
| Al₂O₃ | R-3C (167) | Al (0.00000, 0.00000, 0.35216) | a = b = 4.7650, |
| | | O (0.30668, 0.00000, 0.25000) | c = 13.0024 |
| | | | α = β = 90°, γ = 120° |
| ZrO₂ | Fm-3m | Zr (0.00000, 0.00000, 0.00000) | a = b = c = 5.09 |
| | (225) | O (0.25000, 0.25000, 0.25000) | α = β = γ = 90° |
| LaAlO₃ | Pm-3m | O (0.50000, 0.00000, 0.00000) | a = b = c = 3.81160 |
| | (221) | Al (0.00000, 0.00000, 0.00000) | α = β = γ = 90° |
| | | La (0.50000, 0.50000, 0.50000) | |
| CaO | Fm-3m | Ca (0.00000, 0.00000, 0.00000) | a = b = c = 4.79496 |
| | (225) | O (0.50000, 0.50000, 0.50000) | α = β = γ = 90° |
| MgO | Fm-3m | Mg (0.00000, 0.00000, 0.00000) | a = b = c = 4.21214 |
| | (225) | O (0.50000, 0.50000, 0.50000) | α = β = γ = 90° |
| MnS | Fd-3m | Mn (0.00000, 0.00000, 0.00000) | a = b = c = 5.24000 |
| | (225) | O (0.50000, 0.50000, 0.50000) | α = β = γ = 90° |
| CaS | Fm-3m | Ca (0.00000, 0.00000, 0.00000) | a = b = c = 4.8365 |
| | (225) | S (0.50000, 0.50000, 0.50000) | α = β = γ = 90° |
| TiN | Fm-3m | Ti (0.00000, 0.00000, 0.00000) | a = b = c = 4.24400 |
| | (225) | N (0.50000, 0.50000, 0.50000) | α = β = γ = 90° |
| Al₂MgO₄ | Fd-3m | Mg (0.00000, 0.00000, 0.00000) | a = b = c = 4.79496 |
| | (227) | Al (0.62500, 0.62500, 0.62500) | α = β = γ = 90° |
| | | O (0.37500, 0.37500, 0.37500) | |
| La₂O₇Zr₂ | Fd-3m | La (0.50000, 0.50000, 0.50000) | a = b = c = 10.80760 |
| | (227) | O1 (0.41890, 0.12500, 0.12500) | α = β = γ = 90° |
| | | O2 (0.12500, 0.12500, 0.12500) | |
| | | Zr (0.00000, 0.00000, 0.00000) | |

TABLE 6
Calculation results of physical properties of inclusions and matrix

| | Bulk | Shear | Young's | |
|---|---|---|---|---|
| | modulus | modulus | modulus | Poisson's |
| | (GPa) | (GPa) | (GPa) | ratio |
| Fe (BCC) | 194.76 | 81.52 | 214.61 | 0.32 |
| Al₂O₃ | 249.54 | 152.76 | 380.61 | 0.25 |
| ZrO₂ | 271.06 | 109.14 | 288.68 | 0.32 |
| La₂O₇Zr₂ | 165.83 | 60.56 | 161.95 | 0.34 |
| LaAlO₃ | 192.61 | 121.10 | 300.35 | 0.24 |
| CaO | 114.11 | 78.81 | 192.19 | 0.22 |
| MgO | 165.83 | 127.64 | 304.73 | 0.19 |
| CaS | 57.05 | 39.07 | 95.42 | 0.22 |
| TiN | 175.02 | 79.89 | 208.01 | 0.30 |

### (6) Local Stress Characterization of Complex Inclusions

Electron back-scattering diffraction (EBSD) technology can provide information on crystal orientation, phase distribution and strain of the material microstructure. In this test work, a voltage of 20 kV and a current of 13 nA are selected for the EBSD test. In order to determine the lattice distortion between the inclusions and the matrix, it is necessary to eliminate the influence of external stress on the inclusions as much as possible. Therefore, it is necessary to use an Argon ion polisher (GATAN 685) for further grinding the polished sample. The Image Quality (IQ) map tested by EBSD is mainly used to describe the pattern quality of EBSD. Specifically, the strain distribution in the microstructure is represented by the variation of the pattern quality. For example, when the lattice is distorted, the IQ map will produce diffuse, lower-quality diffraction patterns, and the gray level in the IQ map will increase accordingly. The kernel average misorientation (KAM) map can be used to characterize the homogenization degree of local stress concentration or lattice distortion. Generally, a higher KAM value indicates a higher degree of deformation/dislocation density in the region, and the larger the KAM value, the higher the stress concentration.

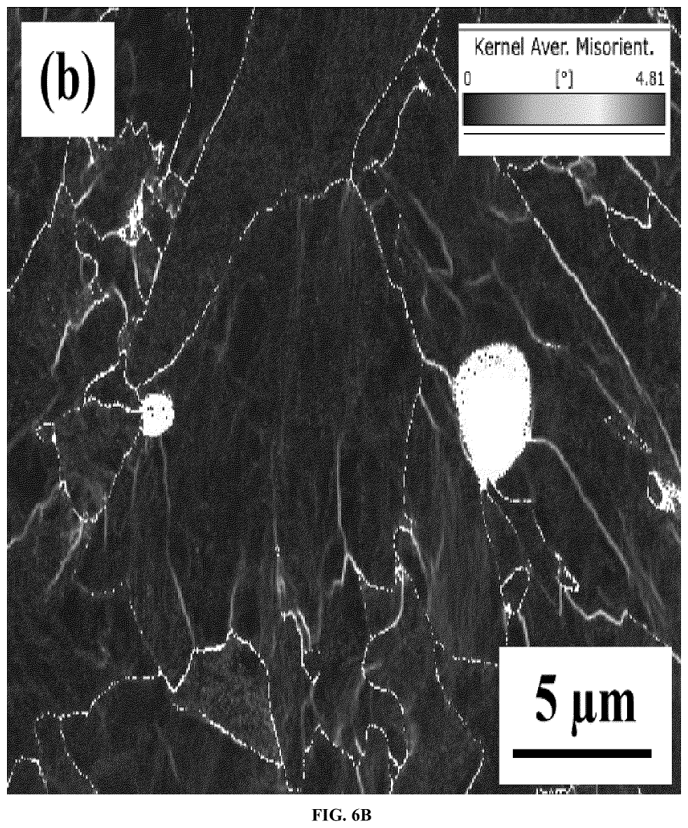

FIGS. 6A-6B show EBSD characterization results of a region containing complex inclusions in a developed steel sample. The results show that the image quality of the IQ map in the sample is clear; and the KAM map shows that the blue (low strain) is mainly around the complex inclusions, that is, there is only a relatively small strain concentration around the complex inclusions. It can be seen that the stress generated in the matrix by the complex inclusions formed after complex deoxidation of rare earth La is very small. The addition of rare earth elements is beneficial to the formation of rare earth complex inclusions in steel, such as LaAlO₃ and La₂O₇Zr₂, which is beneficial to reduce the stress caused by the presence of inclusions.

### (7) Mechanism of Influence of Rare Earth Addition on Physical Properties of Complex Inclusions

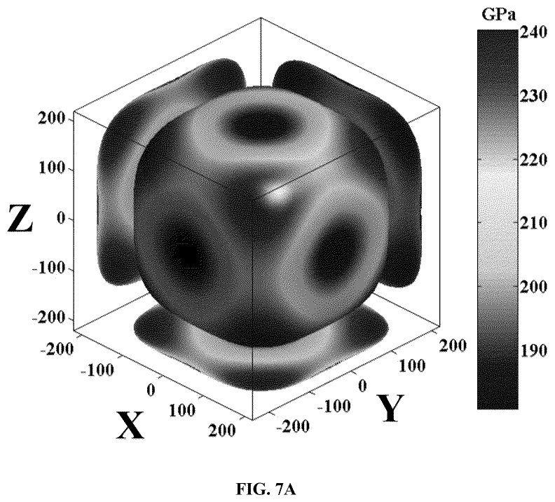

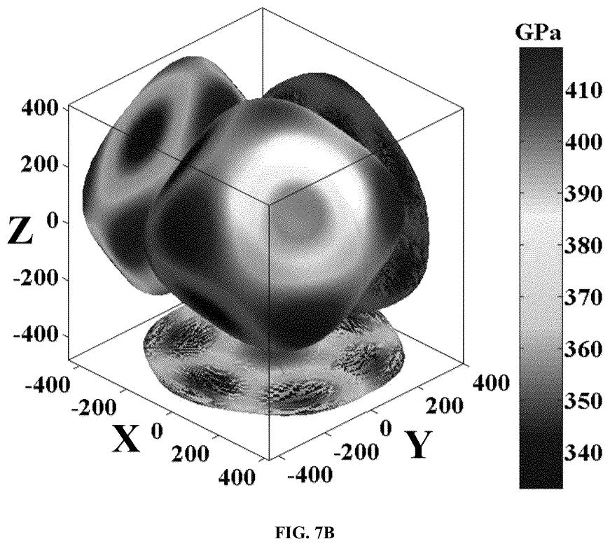

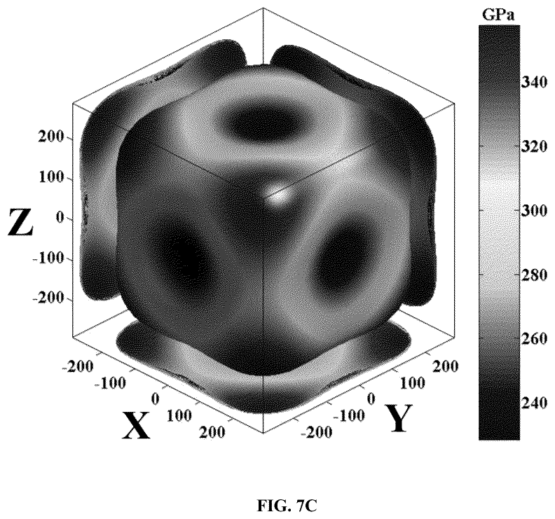

The addition of rare earth elements not only affects the grain size and microstructure, but also affects the type and physical properties of inclusions. Rare earth (RE) elements have a stronger affinity for oxygen and sulfur than Zr. Ti and other deoxidizers, and can form rare earth oxides and rare earth sulfides, as well as rare earth complex inclusions with other deoxidizers, such as LaAlO₃, La₂O₇Zr₂, etc. Compared with Al₂O₃, the bulk modulus of LaAlO₃ is closer to that of Fe matrix, indicating that LaAlO₃ inclusions have similar incompressibility to the matrix. In addition, the Young's modulus of LaAlO₃ is also closer to the Fe matrix (FIGS. 7A-7C), and the Young's modulus is proportional to the hardness of the material, that is, the hardness of the rare earth complex inclusions is closer to that of the matrix.

In summary, compared with the traditional Al deoxidation process, the rare earth complex inclusions formed by the rare earth deoxidation process can reduce the micro gaps between the inclusions and the matrix, resulting in uniform deformation between the inclusions and the iron matrix, which is conducive to improving the mechanical properties, fatigue resistance, localized corrosion resistance, etc. of steel.

It can be seen from the above results that the composite additive and smelting method are especially suitable for steel for marine engineering, steel for pipeline containers, steel for cryogenic containers, steel for bridges, steel for iron towers, steel for tracks, steel for bearings, steel for gears, steel for curtain wires, spring steel, cold heading steel, automobile steel, electrical steel, bridge steel, bridge cable steel, stainless steel, H-shaped steel and other steel types that have strict requirements on the shape of inclusions. The obtained inclusions have fine, spherical, and dispersed complex inclusions with a core-shell structure having a bulk modulus similar to that of the iron matrix, which can significantly improve the corrosion resistance of neutral aqueous media, seawater corrosion resistance, fatigue resistance, plasticity and toughness, and reduce local stress concentration.

In the description of this specification, descriptions referring to the terms “an embodiment”, “some embodiments”, “example”, “specific examples”, or “some examples” mean that specific features, structures, materials or characteristics described in connection with the embodiment or example are included in at least one embodiment or example of the present invention. In this specification, the schematic representations of the above terms are not necessarily directed to the same embodiment or example. Furthermore, the described specific features, structures, materials or characteristics may be combined in any suitable manner in any one or more embodiments or examples. In addition, those skilled in the art can corporate and combine different embodiments or examples and features of different embodiments or examples described in this specification without conflicting with each other.

Although the embodiments of the present invention have been shown and described above, it can be understood that the above embodiments are exemplary and should not be construed as limiting the present invention, those skilled in the art can make changes, modifications, substitutions and variations to the above-mentioned embodiments.

What is claimed is:

1. A composite additive for forming inclusions with a core-shell structure, comprising the following chemical components by a mass percentage: Fe: 41-59%, Zr: 5-11%, Ti: 14-26%, Mg: 11-19%, and rare earth (RE): 4-10%, wherein the mass percentage of the Zr, the Ti, the Mg and the RE satisfies a formula: (Ti+Mg+RE)/Zr=4-8.

2. The composite additive for forming the inclusions with the core-shell structure according to claim 1, comprising the following chemical components by the mass percentage: the Fe: 46-57%, the Zr: 6-11%, the Ti: 15-16%, the Mg: 12-19%, and the RE: 9-10%.

3. The composite additive for forming the inclusions with the core-shell structure according to claim 1, comprising the following chemical components by the mass percentage: the Fe: 50%, the Zr: 8%, the Ti: 20%, the Mg: 15%, and the RE: 7%.

4. The composite additive for forming the inclusions with the core-shell structure according to claim 1, wherein the RE comprises an La element and a Ce element, and a mass ratio of the La element to the Ce element is (70-90):(10-30).

5. The composite additive for forming the inclusions with the core-shell structure according to claim 1, wherein the Zr is sponge metal zirconium and/or metal zirconium; and the Mg is one or a combination of at least two of a metal magnesium block, magnesium grains, magnesium-zirconium alloy blocks, and magnesium-zirconium alloy grains.

6. A method for preparing the composite additive for forming the inclusions with the core-shell structure according to claim 1, comprising the following steps: first adding the Zr, the Ti, and the RE to an Fe—Ti alloy to obtain a resulting product, and then smelting the resulting product in a vacuum induction furnace to obtain a smelted product, and then casting the smelted product under vacuum conditions to obtain the composite additive.

7. The method for preparing the composite additive for forming the inclusions with the core-shell structure according to claim 6, wherein a time for smelting the resulting product in the vacuum induction furnace is 4-8 hours.

8. A smelting method, comprising steps of:
(1) after steelmaking a molten iron and/or a scrap steel using a converter or an electric arc furnace to obtain a resulting steel, adjusting a temperature and a composition of the resulting steel to obtain a molten steel;
(2) making the molten steel enter a ladle, performing a pre-deoxidation on the molten steel first to obtain a pre-deoxidated molten steel, and then performing a final deoxidation on the pre-deoxidated molten steel using the composite additive according to claim 1 to obtain a final deoxidized molten steel; and
(3) refining and continuously casting the final deoxidized molten steel in sequence.

9. The smelting method according to claim 8, wherein a temperature of the molten steel in step (1) is 1551-1690° C., and a free oxygen content in the molten steel is 101-399 ppm; step (2) comprises: making the molten steel enter the ladle, firstly pre-deoxidizing the molten steel in the ladle using an Fe—Si alloy or an Fe—Si—Mn alloy under micro-subbubble stirring, adjusting a free oxygen content in the pre-deoxidated molten steel to 11-99 ppm, and then under the micro-subbubble stirring, performing the final deoxidation on the pre-deoxidated molten steel using the composite additive to obtain the final deoxidized molten steel; and in step (3), the final deoxidized molten steel is firstly subjected to a ladle furnace (LF) refining, a vacuum degassing (VD) refining, or an Ruhrstahl-Heraeus (RH) refining, and then continuously cast.

10. The smelting method according to claim 8, wherein in step (2), an amount of the composite additive added per ton of the pre-deoxidated molten steel is 0.51-4.9 kg.

11. The composite additive for forming the inclusions with the core-shell structure according to claim 2, wherein the RE comprises an La element and a Ce element, and a mass ratio of the La element to the Ce element is (70-90):(10-30).

12. The composite additive for forming the inclusions with the core-shell structure according to claim 3, wherein the RE comprises an La element and a Ce element, and a mass ratio of the La element to the Ce element is (70-90):(10-30).

13. The composite additive for forming the inclusions with the core-shell structure according to claim 2, wherein the Zr is sponge metal zirconium and/or metal zirconium; and the Mg is one or a combination of at least two of a metal magnesium block, magnesium grains, magnesium-zirconium alloy blocks, and magnesium-zirconium alloy grains.

14. The composite additive for forming the inclusions with the core-shell structure according to claim 3, wherein the Zr is sponge metal zirconium and/or metal zirconium; and the Mg is one or a combination of at least two of a metal magnesium block, magnesium grains, magnesium-zirconium alloy blocks, and magnesium-zirconium alloy grains.

15. The method for preparing the composite additive for forming the inclusions with the core-shell structure according to claim 6, wherein the composite additive comprises the following chemical components by the mass percentage: the Fe: 46-57%, the Zr: 6-11%, the Ti: 15-16%, the Mg: 12-19%, and the RE: 9-10%.

16. The method for preparing the composite additive for forming the inclusions with the core-shell structure according to claim 6, wherein the composite additive comprises the following chemical components by the mass percentage: the Fe: 50%, the Zr: 8%, the Ti: 20%, the Mg: 15%, and the RE: 7%.

17. The method for preparing the composite additive for forming the inclusions with the core-shell structure according to claim 6, wherein in the composite additive, the RE comprises an La element and a Ce element, and a mass ratio of the La element to the Ce element is (70-90):(10-30).

18. The method for preparing the composite additive for forming the inclusions with the core-shell structure according to claim 6, wherein in the composite additive, the Zr is sponge metal zirconium and/or metal zirconium; and the Mg is one or a combination of at least two of a metal magnesium block, magnesium grains, magnesium-zirconium alloy blocks, and magnesium-zirconium alloy grains.

19. The smelting method according to claim 8, wherein the composite additive comprises the following chemical components by the mass percentage: the Fe: 46-57%, the Zr: 6-11%, the Ti: 15-16%, the Mg: 12-19%, and the RE: 9-10%.

20. The smelting method according to claim 8, wherein the composite additive comprises the following chemical components by the mass percentage: the Fe: 50%, the Zr: 8%, the Ti: 20%, the Mg: 15%, and the RE: 7%.
